(19) United States
(12) Patent Application Publication
(10) Pub. No.: US 2014/0244578 A1
(43) Pub. Date: Aug. 28, 2014

(54) HIGHLY AVAILABLE MAIN MEMORY DATABASE SYSTEM, OPERATING METHOD AND USES THEREOF

(71) Applicant: FUJITSU TECHNOLOGY SOLUTIONS INTELLECTUAL PROPERTY GMBH, Muenchen (DE)

(72) Inventor: Bernd Winkelstraeter, Paderborn (DE)

(73) Assignee: FUJITSU TECHNOLOGY SOLUTIONS INTELLECTUAL PROPERTY GMBH, Muenchen (DE)

(21) Appl. No.: 14/190,409

(22) Filed: Feb. 26, 2014

(30) Foreign Application Priority Data
Feb. 26, 2013 (DE) 10 2013 101 863.7

(51) Int. Cl. G06F 11/14; G06F 17/30

(52) U.S. Cl. CPC G06F 11/1435; G06F 17/302
USPC 707/617

(57) ABSTRACT

A highly available main memory database system includes a plurality of computer nodes, including at least one computer node that creates a redundancy of the database system. The highly available main memory database system further includes at least one connection structure that creates a data link between the plurality of computer nodes. Each of the computer nodes has a synchronization component that redundantly stores a copy of the data of a database segment assigned to the particular computer node in at least one non-volatile memory of at least one other computer node.

### TECHNICAL FIELD

This disclosure relates to a highly available main memory database system, comprising a plurality of computer nodes with at least one computer node for creating a redundancy of the database system. The disclosure further relates to an operating method for a highly available main memory database system and to a use of a highly available main memory database system as well as a use of a non-volatile mass storage device of a computer node of a main memory database system.

### BACKGROUND

Database systems are commonly known from the field of electronic data processing. They are used to store comparatively large amounts of data for different applications. Typically, because of its volume the data is stored in one or more non-volatile secondary storage media, for example, a hard disk drive, and for querying is read in extracts into a volatile, primary main memory of a database system. To select the data to be read in, in particular in the case of relational database systems, use is generally made of index structures, via which the data sets relevant for answering a query can be selected.

In particular, in the case of especially powerful database applications, it is moreover also known to hold all or at least substantial parts of the data to be queried in a main or working memory of the database system. What are commonly called main memory databases are especially suitable for answering particularly time-critical applications. The data structures used there differ from those of database systems with secondary mass memories, since when accessing the main memory, in contrast to when accessing blocks of a secondary mass storage device, latency is much lower due to random access to individual memory cells. Examples of such applications are inter alia the response to a multiplicity of parallel, comparatively simple requests in the field of electronic data transmission networks, for example, when operating a router or a search engine. Main memory database systems are also used in responding to complex questions for which a substantial part of the entire data of the database system has to be considered. Examples of such complex applications are, for example, what is commonly known as data mining, online transaction processing (OLTP) and online analytical processing (OLAP).

Despite ever-growing main memory sizes, in some cases it is virtually impossible or at least not economically viable for all the data of a large database to be held available in a main memory of an individual computer node to respond to queries. Moreover, providing all data in a single computer node would constitute a central point of failure and bottleneck and thus lead to an increased risk of failure and to a reduced data throughput.

To solve this and other problems, it is known to split the data of a main memory database into individual database segments and store them on and query them from a plurality of computer nodes of a coupled computer cluster. One example of such a computer cluster, which preferably consists of a combination of hardware and software, is known by the name HANA (High-Performance Analytic Appliance) of the firm SAP AG. In essence, the product marketed by SAP AG offers an especially good performance when querying large amounts of data.

Due to the volume of the data stored in such a database system, especially upon failure and subsequent rebooting of individual computer nodes and also when first switching on the database system, considerable delays are experienced as data is loaded into a main memory of the computer node or nodes.

It could therefore be helpful to provide a further improved, highly available main memory database system. Such a main memory database system should preferably allow a reduced latency when loading data into a main memory of individual or a plurality of computer nodes of the main memory database system. In particular, what is known as the failover time, that is, the latency between failure of one computer node and its replacement by another computer node, should be shortened.

### SUMMARY

I provide a highly available main memory database system including a plurality of computer nodes including at least one computer node that creates a redundancy of the database system; and at least one connection structure that creates a data link between the plurality of computer nodes, wherein each of the computer nodes has at least one local non-volatile memory that stores a database segment assigned to the particular computer node, at least one data-processing component that runs database software to query the database segment assigned to the computer node and a synchronization component that redundantly stores a copy of the data of a database segment assigned to a particular computer node in at least one non-volatile memory of at least one other computer node; and upon failure of at least one of the plurality of computer nodes, at least the at least one computer node that creates the redundancy runs the database software to query at least a part of the database segment assigned to the failed computer node based on a copy of associated data in the local non-volatile memory to reduce latency upon failure of the computer node.

I also provide a method of operating the system with a plurality of computer nodes, including storing at least one first database segment in a non-volatile local memory of a first computer node; storing a copy of the at least one first database segment in at least one non-volatile local memory of at least one second computer node; executing database queries with respect to the first database segment by the first computer node; storing database changes with respect to the first database segment in the non-volatile local memory of the first computer node; storing a copy of the database changes with respect to the first database segment in the non-volatile local memory of the at least one second computer node; and executing database queries with respect to the first database segment by a redundant computer node based on the stored copy of the first database segment and/or the stored copy of the database changes should the first computer node fail.

### BRIEF DESCRIPTION OF THE DRAWINGS

FIGS. 1A to 1C show a configuration of a main memory database system according to a first example.

FIG. 2 shows a flow chart of a method of operating the database system according to the first example.

FIGS. 3A to 3D show a configuration of a main memory database system according to a second example.

FIG. 4 shows a flow chart of a method of operating the database system according to the second example.

FIGS. 5A to 5E show a configuration of a main memory database system according to a third example.

FIG. 6 shows a flow chart of a method of operating the database system according to the third example.

FIGS. 7A to 7D show a configuration of a main memory database system according to a fourth example.

FIGS. 8A and 8B show a configuration of a conventional main memory database system.

### LIST OF REFERENCE NUMBERS

100 Main memory database system
110 Computer node
120 First non-volatile mass storage device
130 Second non-volatile mass storage device
140 Serial high speed line
150 Main memory
160 First part of the main memory
170 Second part of the main memory
200 Method
205-270 Method steps
280 First phase
285 Second phase
290 Third phase
300 Main memory database system
310 Computer node
320 Serial high speed line
330 Switching device
340 First memory area
350 Second memory area
400 Method
410-448 Method steps
500 Main memory database system
510 Computer node
520 Network line
530 Network switch
540 First memory area
550 Second memory area
600 Method
605-665 Method steps
700 Main memory database system
710 Computer node
720 Network line
730 Network switch
740 First memory area
750 Second memory area
800 Main memory database system
810 Computer node
820 Network storage device
830 Data connection
840 Synchronization component

### DETAILED DESCRIPTION

I thus provide a highly available main memory database system. The system may comprise a plurality of computer nodes, which comprise at least one computer node to create a redundancy of the database system. The system moreover comprises at least one connection structure to create a data link between the plurality of computer nodes. Each of the computer nodes has at least one local non-volatile memory to store a database segment assigned to the particular computer node and at least one data-processing component to run database software to query the database segment assigned to the computer node. Furthermore, each of the computer nodes has a synchronization component designed to store redundantly a copy of the data of a database segment assigned to the particular computer node in at least one non-volatile memory of at least one other computer node. Upon failure of at least one of the plurality of computer nodes, at least the at least one computer node to create the redundancy is designed to run the database software to query at least a part of the database segment assigned to the failed computer node based on a copy of the associated data in the local non-volatile memory to reduce the latency upon failure of the computer node.

Differing from known systems, in the described main memory database system in each case a database segment is stored in a local non-volatile memory of the computer node, which also serves to query the corresponding database segment. The local storage enables a maximum bandwidth, for example, a system bus bandwidth or a bandwidth of an I/O bus of a computer node, to be achieved when transferring the data out of the local non-volatile memory into the main memory of the main memory database system. For the local storage to create a redundancy of the stored database segment via the synchronization component, a copy of the data is additionally redundantly stored in at least one non-volatile memory of at least one other computer node. In addition to the actual data of the database itself, the database segment can also comprise further information, in particular transaction data and associated log data.

Upon failure of one of the computer nodes, the database segment stored locally in the failed computer node can therefore be recovered, based on the copy of the data in a different computer node, without a central memory system such as a central network storage device being required. The computer nodes of the database system here serve both as synchronization source and as synchronization destination. By recovering the failed database segment from one or a plurality of computer nodes it is possible to achieve an especially high bandwidth when loading the database segment into the computer nodes to create the redundancy.

By exploiting a local storage and a high data transmission bandwidth between the individual computer nodes, what is known as the failover time, i.e., the latency that follows the failure of a computer node is minimized. In other words, I combine the speed advantages of a storage of the required data that is as local as possible with the creation of a redundancy by the distribution of the data over a plurality of computer nodes to reduce the failover time at the same time as maintaining protection against system failure.

Based on currently predominant computer architecture, the database segment is permanently stored, for example, in a non-volatile secondary mass storage device of the computer nodes and to process queries is loaded into a volatile, primary main memory of the relevant computer node. On failure of at least one computer node, the computer node to create the redundancy loads at least a part of the database segment assigned to the failed computer node from a copy in the non-volatile mass storage device via a local bus system into the volatile main memory for querying. By loading data via a local bus system, a locally available high bandwidth can be used to minimize the failover time.

The at least one data processing component of a computer node may be connected via at least one direct-attached storage (DAS) connection to the non-volatile mass storage device of the computer node. In addition to known connections, for example, based on the Small Computer System Interface (SCSI) or the Peripheral Connect Interface Express (PCIe), new kinds of non-volatile mass storage devices and the interfaces thereof can also be used to further increase the transmission bandwidth, for example, those known as DIMM-SSD memory modules, which can be plugged directly into a slot to receive a memory module on a system board of a computer node.

Furthermore, it is also possible to use a non-volatile memory itself as the main memory of the particular computer node. In that case, the non-volatile main memory contains at least a part of or the whole database segment assigned to the particular computer node as well as optionally a part of a copy of a database segment of a different computer node. This concept is suitable in particular for new and future computer structures, in which a distinction is no longer made between primary and secondary storage.

The participating computer nodes can be coupled to one another using different connection systems. For example, provision of a plurality of parallel connecting paths, in particular a plurality of what are called PCIe data lines, is suitable for an especially high-performance coupling of the individual computer nodes. Alternatively or in addition, one or more serial high speed lines, for example, according to the InfiniBand (IB) standard, can be provided. The computer nodes are preferably coupled to one another via the connection structures such that the computer node to create the redundancy is able according to a Remote Direct Memory Access (RDMA) protocol to access directly the content of a memory of at least one other computer node, for example, the main memory thereof or a non-volatile mass storage device connected locally to the other nodes.

The architecture can be organized in different configurations depending on the size and requirements of the main memory database system. In a single-node failover configuration, the plurality of computer nodes comprises at least one first and one second computer node, wherein an entire queryable database is assigned to the first computer and stored in the non-volatile local memory of the first computer node. A copy of the entire database is moreover stored redundantly in the non-volatile local memory of the second computer node, wherein in a normal operating state the database software of the first computer node responds to queries to the database and database changes caused by the query are synchronized with the copy of the database stored in the non-volatile memory of the second computer node. The database software of the second computer node responds to queries to the database at least upon failure of the first computer node. Due to the redundant provision of data of the entire database in two computer nodes, when the first computer node fails queries can continue to be answered by the second computer node without significant delay.

In a further configuration, commonly called a multi-node failover configuration, suitable in particular for use of particularly extensive databases, the plurality of computer nodes comprises a first number n, n>1, of active computer nodes. Each of the active computer nodes is designed to store in its non-volatile local memory a different one of in total n independently queryable database segments as well as at least one copy of the data of at least a part of a database segment assigned to a different active computer node. By splitting the database into a total of n independently queryable database segments, which are assigned to a corresponding number of computer nodes, even particularly extensive data can be queried in parallel and, hence, rapidly. Through the additional storage in a non-volatile local memory of at least a part of a database segment assigned to a different computer node, the redundancy of the stored data in the event of failure of any active computer node is preserved.

The plurality of computer nodes may additionally comprise a second number m, m≧1, of passive computer nodes to create the redundancy, to which in a normal operating state no database segment is assigned. In such an arrangement, at least one redundant computer node that is passive in normal operation is available to take over the database segment of a failed computer node.

Each of the active computer nodes may be designed, upon failure of another active computer node, to respond in addition to queries relating to the database segment assigned to itself also to at least some queries relating to the database segment assigned to the failed computer node, based on the copy of the data of the corresponding database segment stored in the local memory of the particular computer node. In this manner, loading a database segment of a failed computer node by a different computer node can be at least temporarily avoided, which means that there is no significant delay in responding to queries to the highly available main memory database system.

I also provide an operating method for a highly available main memory database system with a plurality of computer nodes. The operating method comprises the following steps:
storing at least one first database segment in a non-volatile local memory of a first computer node;
storing a copy of the at least one first database segment in at least one non-volatile local memory of at least one second computer node;
executing database queries with respect to the first database segment by the first computer node;
storing database changes with respect to the first database segment in the non-volatile local memory of the first computer node;
storing a copy of the database changes with respect to the first database segment in the non-volatile local memory of the at least one second computer node; and
executing database queries with respect to the first database segment by a redundant computer node based on the stored copy of the first database segment and/or the stored copy of the database changes should the first computer node fail.
The described steps enable database segments to be stored locally in a plurality of computer nodes, wherein simultaneously redundancy of the database segments to be queried is preserved so that corresponding database queries can continue to be answered in the event of failure of the first computer node. Storage of the data required for that purposed in a local memory of a second computer node enables the failover time to be reduced.

The method may comprise the step of recovering the first database segment in a non-volatile local memory of the redundant and/or failed computer node based on the copy of the first database segment and/or the copy of the database changes of the first database segment stored in the at least one non-volatile memory of the at least one second computer node. By loading the database segment and associated database changes from a local non-volatile memory of a different computer node, an especially high bandwidth can be achieved when recovering the failed database segment.

At least a part of at least one other database segment that was redundantly stored in the failed computer node may be copied by at least one third computer node into the non-volatile memory of the redundant and/or failed computer node to restore a redundancy of the other database segment.

The main memory database system and the operating method are suitable in particular for use in a database device, in particular an online analytical processing (OLAP) or online transaction processing (OLTP) database appliance.

I further provide for the use of a non-volatile mass storage device of a computer node of a main memory database system that recovers a queryable database segment in a main memory of the computer node via a local, for example, node-internal, bus system. Use of the non-volatile mass storage device serves inter alia to reduce latency during starting or take-over of a database segment by use of a high local bus bandwidth. Compared to retrieval from a central storage server of a database segment to be recovered, this results inter alia in a reduced failover time following failure of a different computer node of the main memory database system.

My systems, methods and uses are described in detail hereafter by different examples with reference to the appended figures. Similar components are distinguished by appending a suffix. If the suffix is omitted, the remarks apply to all instances of the particular component.

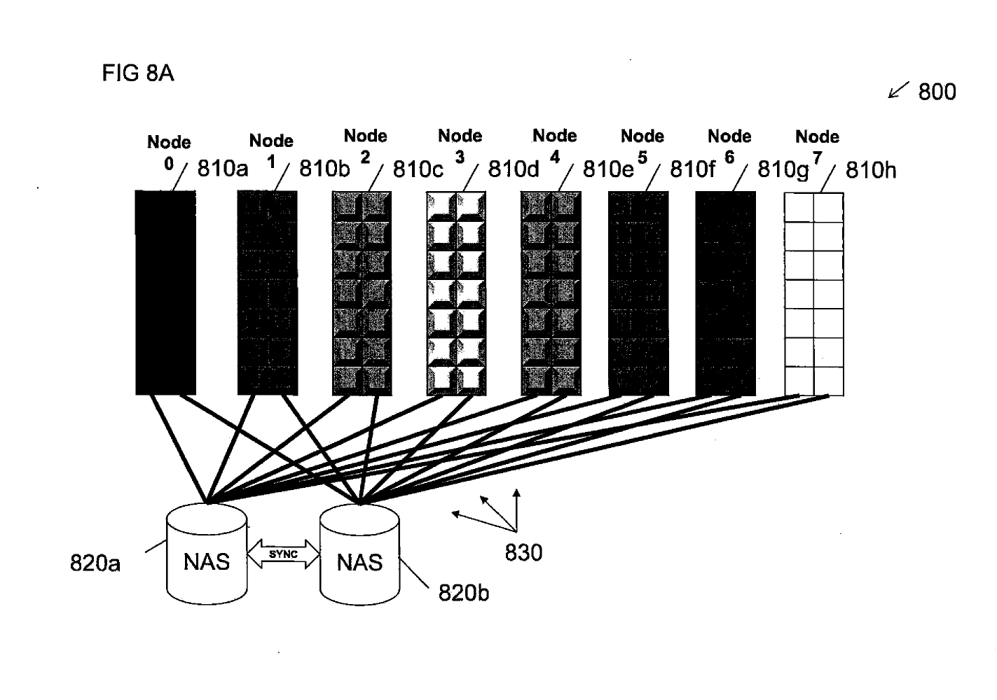

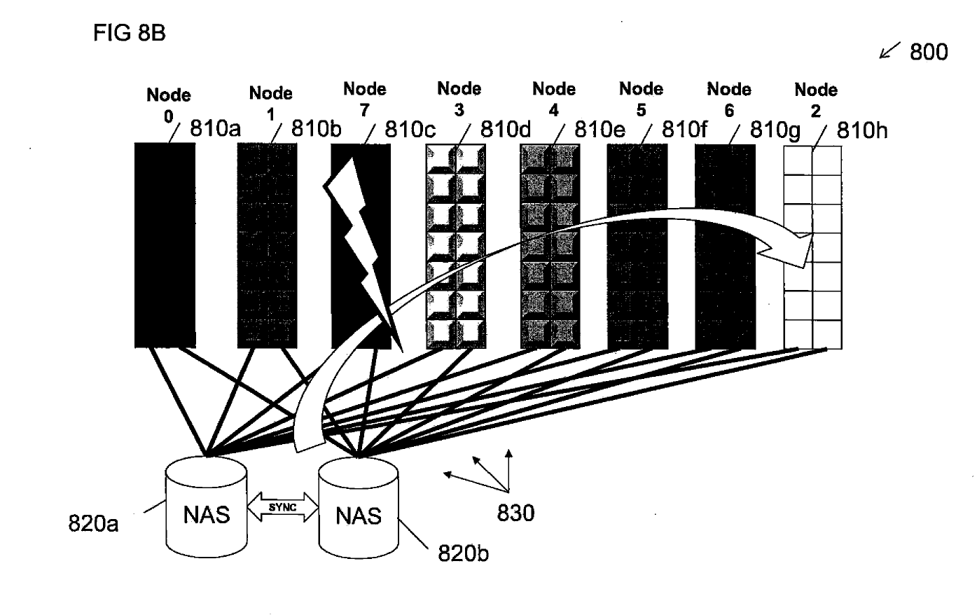

For better understanding, a conventional architecture of a main memory database system with a plurality of computer nodes, and operation of the system will be described with reference to FIGS. 8A and 8B.

FIG. 8A shows a main memory database system 800 comprising a total of eight computer nodes 810a to 810h denoted in FIG. 8A as “Node 0” to “Node 7.” In the example illustrated the main memory database system 800 moreover comprises two network storage devices 820a and 820b for non-volatile storage of all data of the main memory database system 800. For example, these may be network-attached storage (NAS) or storage area network (SAN) components. Each of the computer nodes 810 is connected via a respective data link 830, for example, a LAN or SAN connection, to each of the first and second network storage devices 820a and 820b. Moreover, the two network storage devices 820a and 820b are connected to one another via a synchronization component 840 to allow a comparison of redundantly stored data.

The main memory database system 800 is configured as a highly available cluster system. In the context of the illustrated main memory database, this means in particular that the system 800 must be protected against the failure of individual computer nodes 810, network storage devices 820 and connections 830. For that purpose, in the illustrated example the eighth computer node 810h is provided as the redundant computer node, while the remaining seven computer nodes 810a to 810g are used as active computer nodes. Thus, of the total of eight computer node 810 only seven are available for processing queries.

On the part of the network storage devices 820, the redundant storage of the entire database on two different network storage devices 820a and 820b and the synchronization thereof via the synchronization component 840 ensures that the entire database is available even in the event of failure of one of the two network storage devices 820a or 820b. Because of the likewise redundant data links 830, each of the computer nodes 810 can always access at least one network storage device 820.

The problem with the architecture according to FIG. 8A is that in the event of failure of a single computer node 810, for example, the third computer node 810c, the computer node 810h previously held ready as the redundant computer node has to load the entire database segment previously assigned to the computer node 810c from one of the network storage devices 820a and 820b. This situation is illustrated in FIG. 8B.

Although loading the memory content of the failed computer node 810c of the architecture illustrated in FIG. 8B via the connections 830 is in principle possible, because of the central nature of the network storage devices 820 and the network technologies typically used in practice to connect them to the individual computer nodes 810 such as the Ethernet, for example, the achievable data transmission rate is limited. In addition, the computer node 810h has to share the available bandwidth of the network storage devices 820 with the remaining active computer nodes 810a, 810b and 810d to 810g. These nodes use the network storage devices 820 inter alia to file transaction data and associated log data. In particular when restoring a computer node 810 of a high-performance main memory database system such as, for example, database systems with computer nodes having several terabytes of main memory, considerable delays may therefore occur. Based on a computer node 810 having, for example, eight processors and 12 TB of main memory, assuming 6 TB of database segment data to be recovered from the network storage device 820 and the evaluation of 4 TB of associated log data, this would give a data amount of 10 TB to be loaded on failure of a computer node. With an assumed data transmission rate of 40 Gbits/s of the data link 830, for example, based on the 40 Gbit Ethernet standard, this would therefore mean a recovery time of about 33 minutes which is often unacceptable, in particular in the operation of real-time systems.

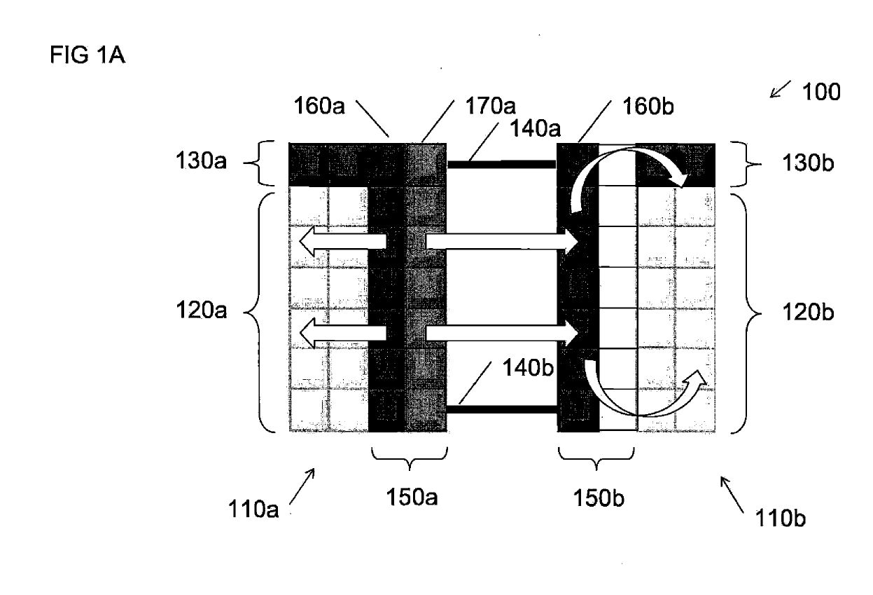

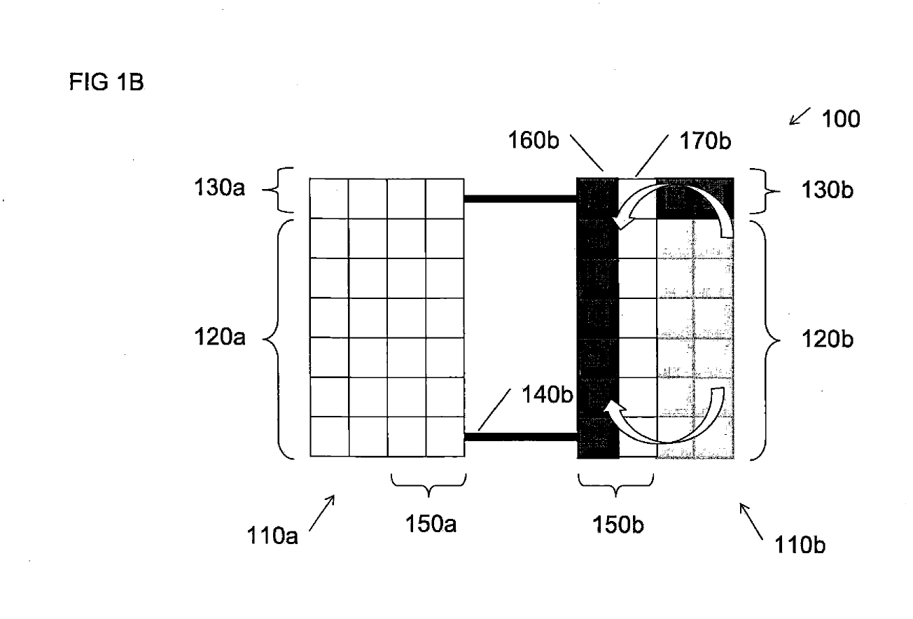

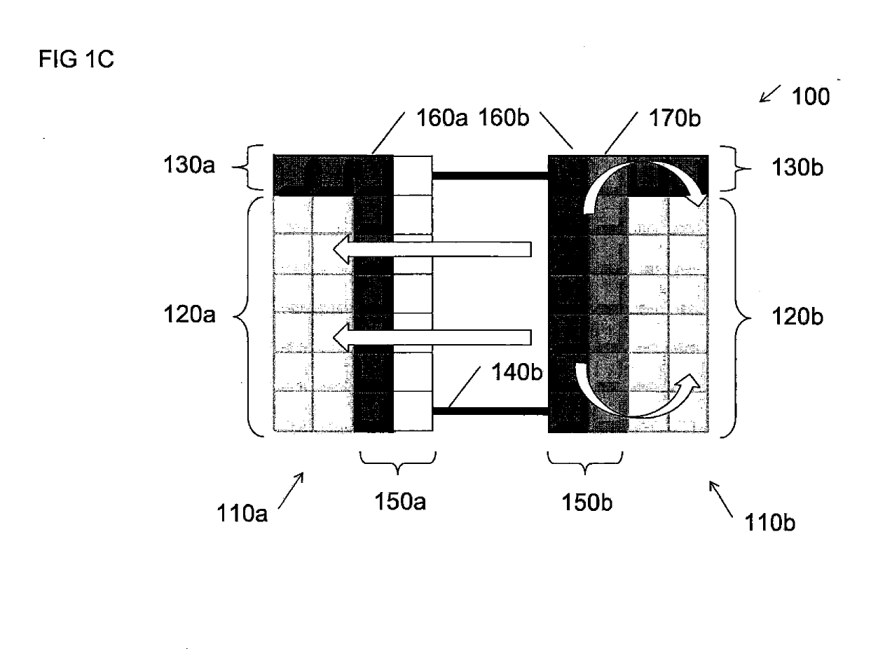

FIG. 1A shows a first example of a main memory database system 100 according to one of my arrangements. The main memory database system 100 comprises in the example two computer nodes 110a and 110b. Each of the computer nodes 110a and 110b comprises a first non-volatile mass storage device 120a and 120b, respectively, and a second non-volatile mass storage device 130a and 130b, respectively. The data of the queryable database are loaded onto the first non-volatile mass storage devices 120a and 120b, respectively. Associated log data and/or other transaction data relating to the changes made to the data of the first non-volatile mass storage devices 120a and 120b, respectively, are stored in the second non-volatile mass storage devices 130a and 130b, respectively. These are internal mass storage devices connected via PCIe to a system component of the particular computer node 110. In particular in the case of the second mass storage device 130, this is preferably an especially fast PCIe-SSD drive or what is commonly called a DIMM-SSD.

In the example according to FIG. 1A the two computer nodes 110a and 110b connect to one another via two serial high speed lines 140a, 140b that are redundant in relation to each other. In the example the serial high speed lines 140a and 140b are, for example, what are commonly called InfiniBand links.

In the main memory database system 100 according to FIG. 1A just one computer node, in FIG. 1A the first computer node 110a, is active. For that purpose an operating system and other system software components and the database software required to answer database queries are loaded into a first part 160a of a main memory 150a. In addition, on this computer node 110a the complete current content of the database is also loaded out of the first non-volatile memory 120a into a second part 170a of the main memory 150a. During execution of queries, changes can occur to the data present in the main memory. These are logged by the loaded database software in the form of transaction data and associated log data on the second non-volatile mass storage device 130a. After logging the transaction data or in parallel therewith, the data of the database stored in the first non-volatile mass storage device 120a is also changed.

Alternatively, the main memory database system 100 can also be operated in an “active/active configuration.” In this case, a database segment is loaded in both computer nodes and can be queried by the database software. The databases here can be two different databases or one and the same database, which is queried in parallel by both computer nodes 110. For example, the first computer node 110a can execute queries that lead to changes to the database segment, and parallel thereto the second computer node 110b can carry out further queries in a read-only mode which do not lead to database changes.

To protect the main memory database system 100 against an unexpected failure of the first computer node 110a, during operation of the first computer node 110a, all changes to the log data or the actual data that occur are also transmitted by a local synchronization component, in particular software to synchronize network resources via the serial high speed lines 140a and/or 140b to the second, passive computer node 110b. In the main memory 150b thereof, in the state illustrated in FIG. 1A, an operating system with synchronization software running thereon is likewise loaded in a first part 160b. The synchronization software accepts the data transmitted from the first computer node 110a and synchronizes it with the data stored on the first and second non-volatile mass storage devices 120b and 130b, respectively. Furthermore, database software used to query can be loaded into the first part 160b of the main memory 150b.

To exchange and synchronize data between the computer nodes 110a and 110b, protocols and software components known in the art to synchronize data can be used. In the example, the synchronization is carried out via the SCSI RDMA protocol (SRP), via which the first computer node 110a transmits changes via a kernel module of its operating system into the main memory 150b of the second computer node 110b. A further software component of the second computer node 110b ensures that the changes are written into the non-volatile mass storage devices 120b and 130b. In other words, the first computer node 110a serves as synchronization source or synchronization initiator and the second computer node 110b as synchronization destination or target.

In the configuration described, database changes are only marked in the log data as successfully committed when the driver software used for the synchronization has confirmed a successful transmission to either the main memory 150b or the non-volatile memory 120b and 130b of the remote computer node 110b. Components of the second computer node 110b that are not required for the synchronization of the data such as additional processors, can optionally be switched off or operated with reduced power to reduce their energy consumption.

In the example, monitoring software which constantly monitors the operation of the first, active computer node 110a furthermore runs on the second computer node 110b. If the first computer node 110a fails unexpectedly, as illustrated in FIG. 1B, the data of the database segment required for continued operation of the main memory database system 100 is loaded out of the first non-volatile mass storage device 120b and the associated log data is loaded out of the second non-volatile mass storage device 130b into a second part 160b of the main memory 150b of the second computer node 110b to recover a consistent database in the main memory 150b. The data transmission rate achievable here is clearly above the data transmission rate that can be achieved with common network connections. For example, when using several what are solid-state discs (SSD) connected parallel to one another via a PCIe interface, a data transmission rate of currently 50 to 100 GB/s can be achieved. Starting from a data volume of about 10 TB to be recovered, the failover time will therefore be about 100 to 200 seconds. This time can be further reduced if the data is currently held not only in the mass storage devices 120b and 130b but is also loaded wholly or partially in passive mode in the second part 170b of the main memory 150b of the second computer node 110b and/or synchronized with the second part 170a of the main memory 150a. The database software of the second computer node 110b then takes over the execution of incoming queries.

As soon as the first computer node 110a is available again, for example, following a reboot of the first computer node 110a, it assumes the role of the passive backup node. This is illustrated in FIG. 1C. The first computer node 110a thereafter accepts the data and log changes caused in the meantime by the second computer node 110b so that on failure of the second computer node 110b there is again a redundant computer node 110a available.

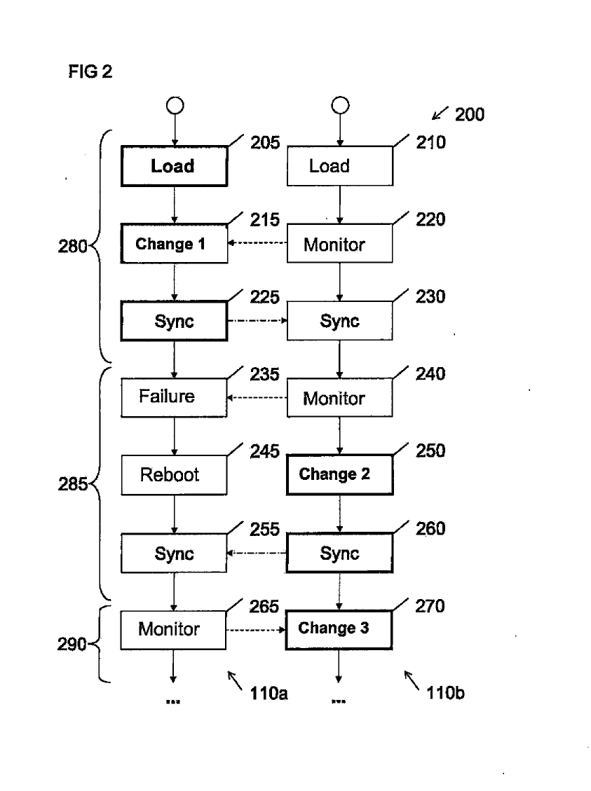

FIG. 2 illustrates an operating method of operating the main memory database system 100. The steps executed by the first computer node 110a are shown on the left and the steps executed by the second computer node 110b are shown on the right. The method steps of the currently active computer node 110 are highlighted in bold type.

In a first step 205 the first computer node 110 loads the programs and data required for operation. For example, an operating system, database software running thereon and also the actual data of the database are loaded from the first non-volatile mass storage device 120a. In parallel therewith in step 210 the second computer node likewise loads the programs required for operation and, if applicable, associated data. For example, the computer node 110b loads first of all only the operating system and monitoring and synchronization software running thereon into the first part 160b of the main memory 150b. Optionally, the database itself can also be loaded from the mass storage device 120b into the second part 170b of the working memory of the second computer node 110b. The main memory database system is now ready for operation.

Subsequently, in step 215, the first computer node 110a carries out a first database change to the loaded data. Parallel therewith in step 220 the second computer node 110b continuously monitors operation of the first computer node 110a. Data changes occurring on execution of the first query are transferred in the subsequent steps 225 and 230 from the first computer node 110a to the second computer node 110b and filed in the local non-volatile mass storage devices 120a and 120b, and 130a and 130b, respectively. Alternatively or additionally, the corresponding main memory contents can be compared. Steps 215 to 230 are executed until the first computer node 110a is running normally.

If in a subsequent step 235 the first computer node 110a fails, this is recognized in step 240 by the second computer node 110b. Depending on whether the database has already been loaded in step 210 or not, the second computer node now loads the database to be queried from its local non-volatile mass storage device 120b and, if necessary, carries out not yet completed transactions according to the transaction data of the mass storage device 130b. Then, in step 250 the second computer node undertakes the answering of further queries, for example, of a second database change. Parallel therewith the first computer node 110a is rebooted in step 245.

After successful rebooting, the database changes carried out by the second computer node 110b and the queries running thereon are synchronized with one another in steps 255 and 260 as described above, but in the reverse data flow direction. In addition, the first computer node 110a undertakes in step 265 the monitoring of the second computer node 110b. The second computer node now remains active to execute further queries, for example, a third change in step 270, until a node failure is again detected and the method is repeated in the reverse direction.

As illustrated in FIG. 2, the main memory database system 100 is in a highly available operational state in a first phase 280 and a third phase 290, in which the failure of any computer node 110 does not involve data loss. Only in a temporary second phase 285 is the main memory database system 100 not in a highly available operational state.

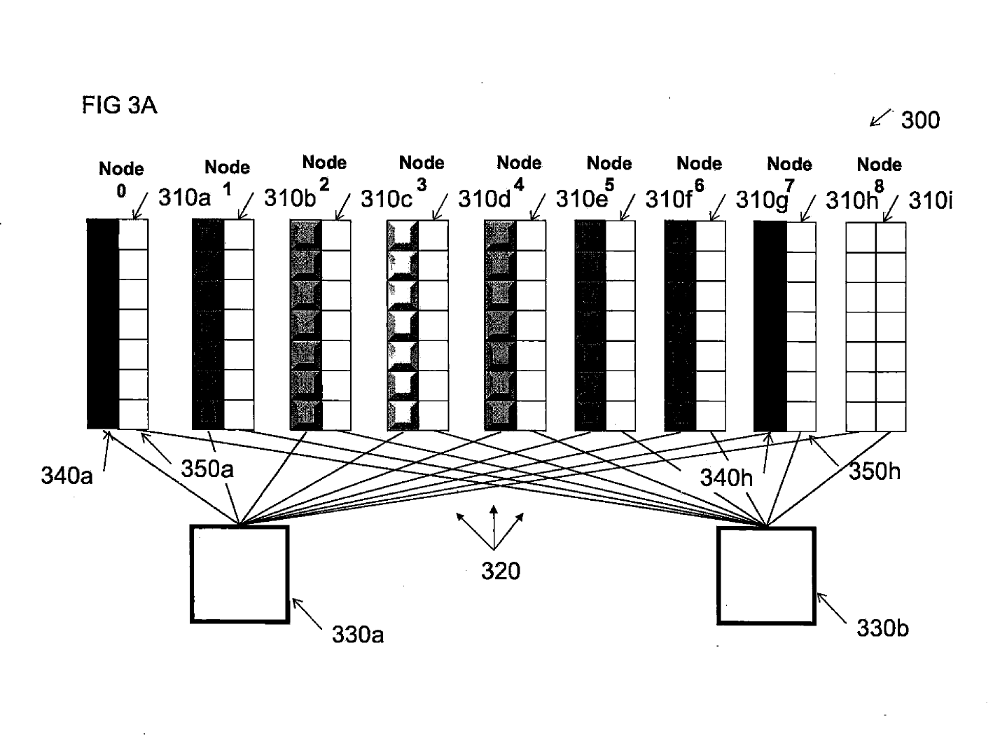

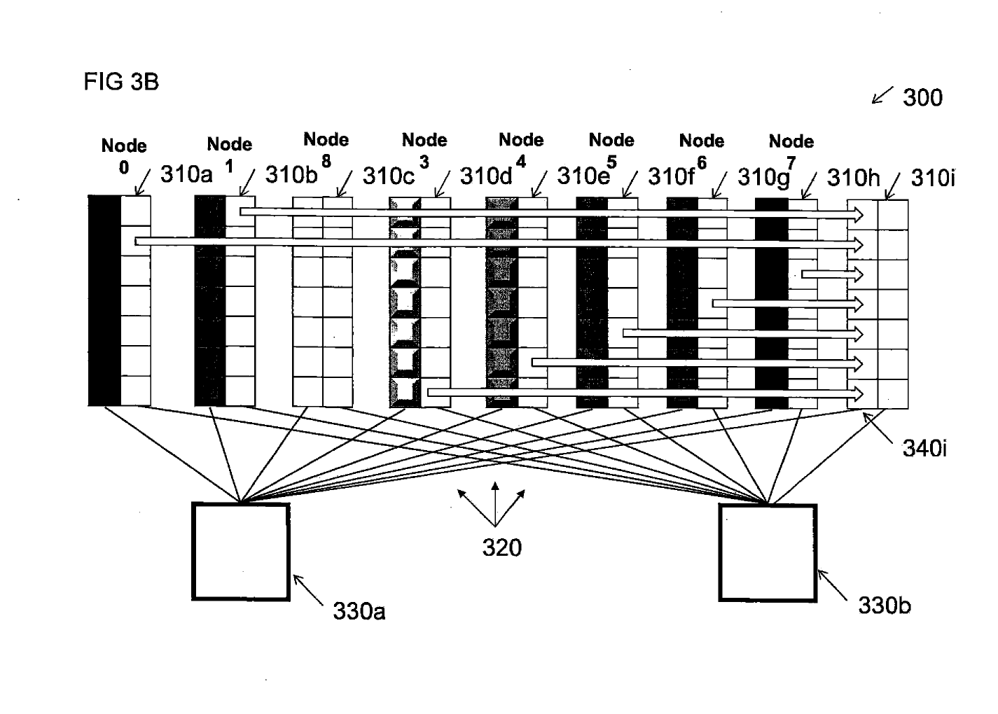

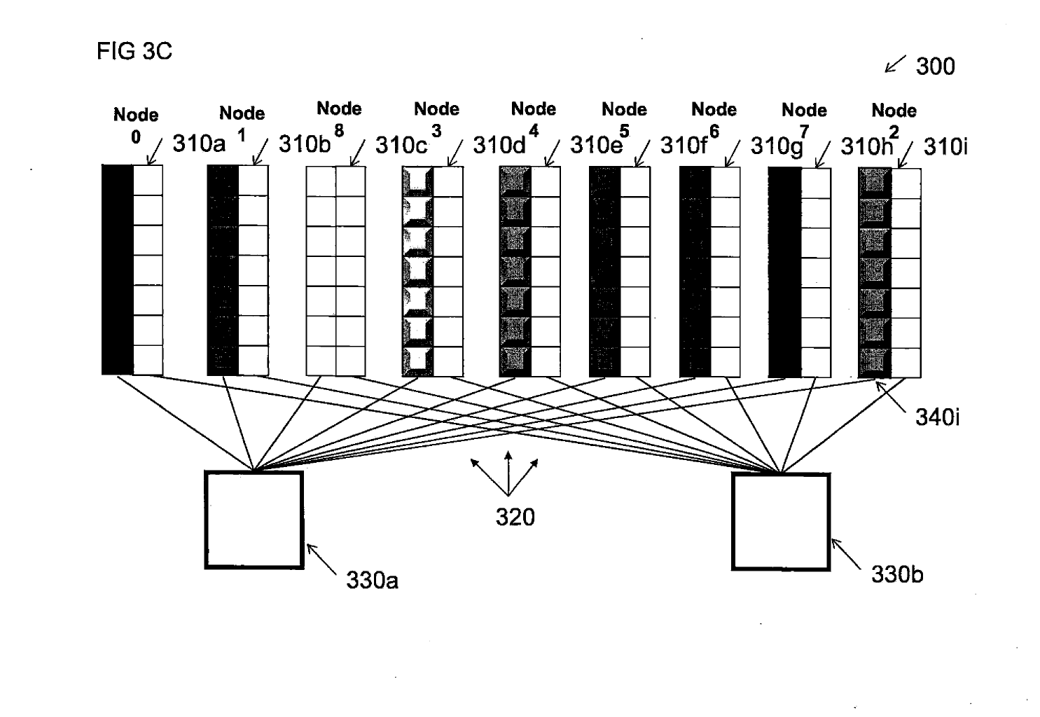

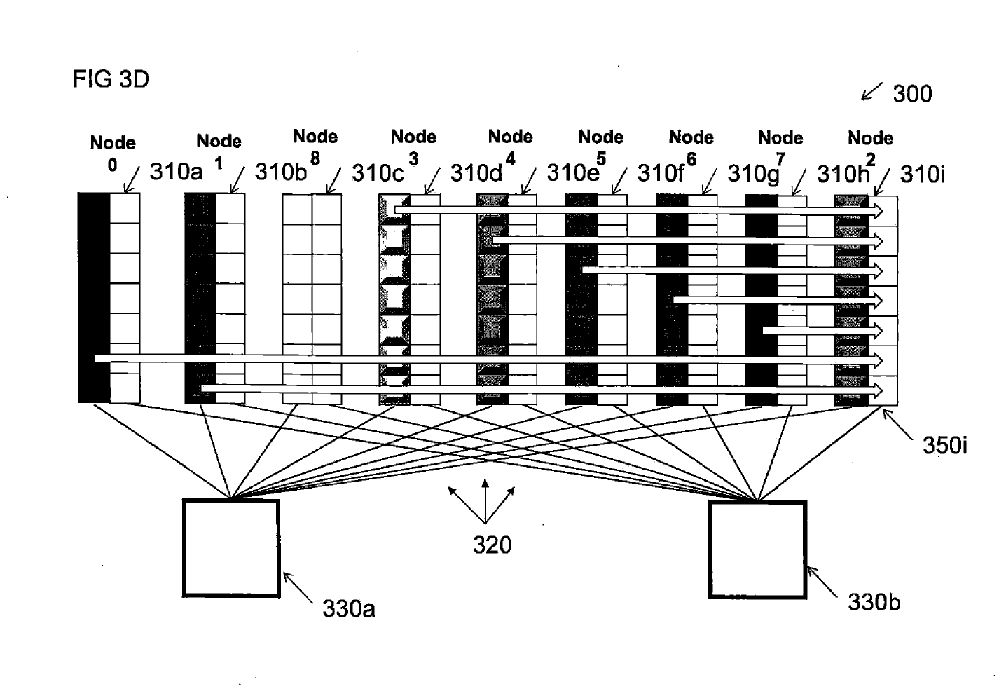

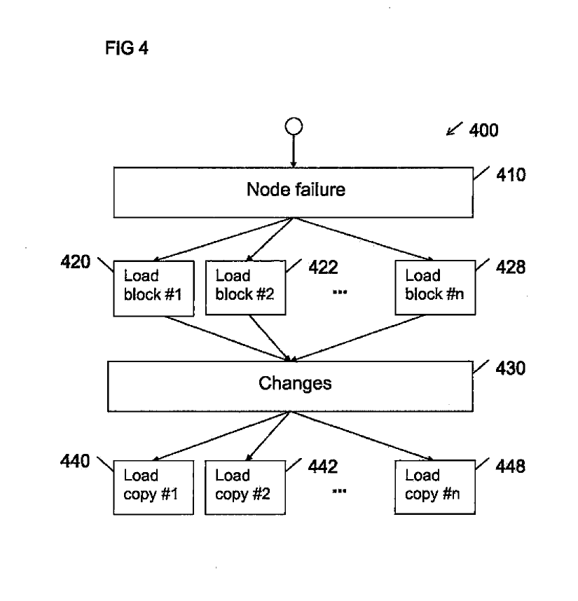

FIGS. 3A to 3D illustrate different states of a main memory database system 300 in an n+1 configuration according to a further example. Operation of the main memory database system 300 according to FIGS. 3A to 3D is explained by the flow chart according to FIG. 4.

FIG. 3A illustrates the basic configuration of the main memory database system 300. In the normal operating state the main memory database system 300 comprises eight active computer nodes 310a to 310h and a passive computer node 310i, which is available as a redundant computer node for the main memory database system 300. All computer nodes 310a to 310i connect to one another via serial high speed lines 320 and two switching devices 330a and 330b that are redundant in relation to one another.

In the normal operating state illustrated in FIG. 3A, each of the active nodes 310a to 310h queries one of a total of eight database segments. These are each loaded into a first memory area 340a to 340h of the active computer nodes 310a to 310h. As can be seen from FIG. 3A, the corresponding database segments fill the available memory area of each computer node 310 only to approximately half way. In a currently customary computer architecture, the memory areas illustrated can be memory areas of a secondary, non-volatile local mass storage device, for example, an SSD-storage drive or a DIMM-SSD memory module. In this case, for querying by the database software, at least the data of the database segment assigned to the particular computer node is additionally cached in a primary volatile main memory, normally formed by DRAM memory modules. Alternatively, storage in a non-volatile working memory is conceivable, for example, battery-backed DRAM memory modules or new types of NVRAM memory modules. In this case, a querying and updating of the data can be carried out directly from or in the non-volatile memory.

In a second memory area 350a to 350h of each active computer node 3310a to 310h, different parts of the data of the database segments of each of the other active computer nodes 310 are stored. In the state illustrated in FIG. 3A, the first computer node 310a comprises, for example, a seventh of each of the database segments of the remaining active computer nodes 310b to 310h. The remaining active computer nodes are configured in an equivalent manner so that each database segment is stored once completely in one active computer node 310 and is stored redundantly distributed over the remaining seven computer nodes 310. In the case of a symmetrical distribution of a configuration with n active computer nodes 310 in general, a part in each case amounting to 1/(n−1) of every other database segment is stored in each computer node 310. Using the flow chart according to FIG. 4 as an example, the failure and subsequent replacement of the computer node 310c will be described hereinafter. The method steps illustrated in the figure are executed in the described example by the redundant computer node 310i.

In a first step 410 the occurrence of a node failure in the active node 310c is recognized. For example, monitoring software that monitors the proper functioning of the active nodes 310a to 310h is running on the redundant computer node 310i or on an external monitoring component. As soon as the node failure has been recognized, the redundantly stored parts of the database segment assigned to the computer node 310c are transferred in steps 420 to 428 out of the different remaining active computer nodes 310a and 310b and 310d to 310h into the first memory area 340i of the redundant computer node 310i and collected there. This is illustrated in FIG. 3B.

In the example, loading is carried out from local non-volatile storage devices, in particular what are commonly called SSD drives, of the individual computer nodes 310a, 310b and 310d to 310h. The data loaded from the internal storage device is transferred via the serial high speed lines 320 and the switching device 330, in the example redundant four-channel InfiniBand connections and associated InfiniBand switches, to the redundant computer node 310i and filed in its local non-volatile memory and loaded into the main memory. As illustrated in FIG. 3B, the transmission independently of one another of the individual parts of the database segment to be recovered provides a high degree of parallelism so that a data transmission rate higher by the number of the parallel nodes or channels than when retrieving the corresponding database segment from a single computer node 310 or a central storage device can be achieved. An asymmetric connection topology, as described later, is preferably used for this purpose.

If the corresponding database segment of the main memory database system 300 has been successfully recovered in the previously redundant computer node 310i, this takes over the function of the computer node 310c and becomes an active computer node 310. This is illustrated in FIG. 3C by swapping the corresponding designations “Node 2” and “Node 8.” For that purpose the recovered database segment is optionally loaded out of the local non-volatile memory into a volatile working memory of the computer node 310i. Even in this state further database queries and/or changes can successfully be processed by the main memory database system 300 in a step 430.

In the following steps 440 to 448, redundancy of the stored data is additionally restored. This is illustrated in FIG. 3D. For this purpose each of the other active computer nodes 310a, 310b and 310d to 310h transfers a part of its database segment to the computer node 310i which has taken over the tasks of the failed computer node 310c and files the transferred copies in a second memory area 350i of a local non-volatile memory. As a result, the previous content of the second memory area 350c plus changes made in the meantime is recovered in the second memory area 350i. Restoration of the redundant data storage of the other database segments can also be carried out with a high degree of parallelism by different, in each case local, mass storage devices of different network nodes 310 so that even a short time after failure of the computer node 310c the redundancy of the stored data is restored. The main memory database system 300 is then again in a highly available operating mode, as before the node failure in step 410.

On completion of the procedure 400, the failed computer node 310c can be rebooted or brought in some other way into a functional operating state again. The computer node 310c is integrated into the main memory database system 300 again and subsequently takes over the function of a redundant computer node 310 designated “Node 8.”

In the case of the computer configuration illustrated in FIGS. 3A to 3D with a dedicated redundant computer node 310i, the data transmission rate and hence what is commonly called the failover time can be improved if the links via the high speed lines 320 are asymmetrically configured. For example, it is possible to provide a higher data transmission bandwidth between the switching devices 330 and the indicated redundant computer node 310i than between the switching devices 330 and the normally active nodes 310a to 310h. This can be achieved, for example, by a higher degree of connecting lines connected in parallel to one another.

Optionally, after rebooting the failed node 310c, the contents of the redundant computer node 310i can be retransferred in anticipation to the re-booted computer node 310c. For example, with all computer nodes 310 being fully operational, a retransfer can be carried out in an operational state with low workload distribution. This is especially advantageous in the case of the above-described configuration with the dedicated redundant computer node 310i to be able to call upon the higher data transmission bandwidth of the asymmetric connection structure upon the next node failure as well.

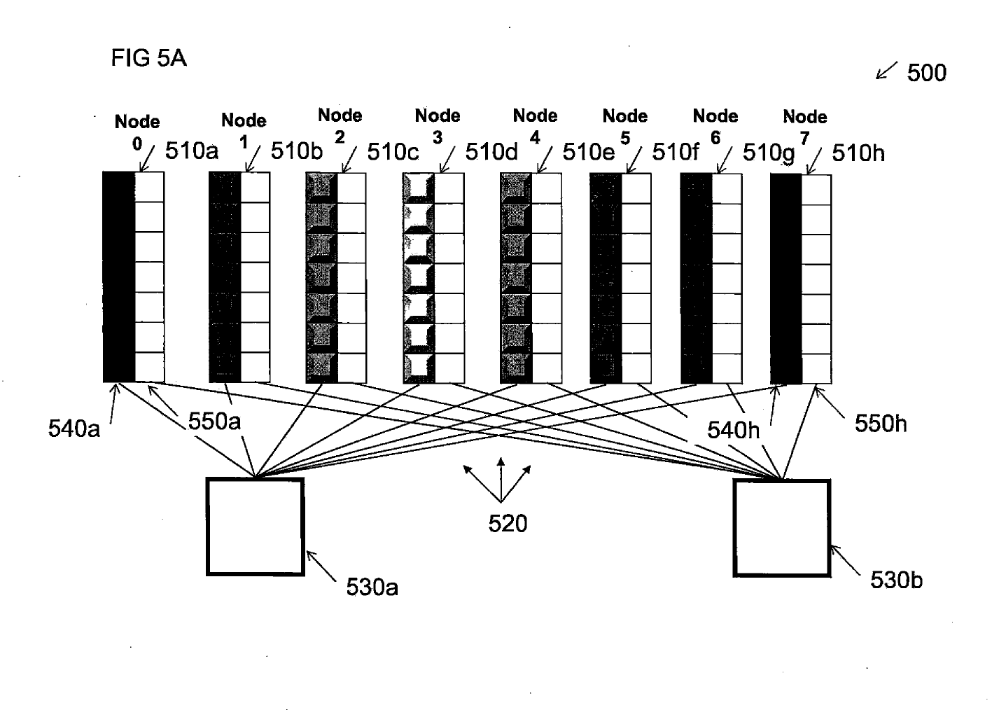

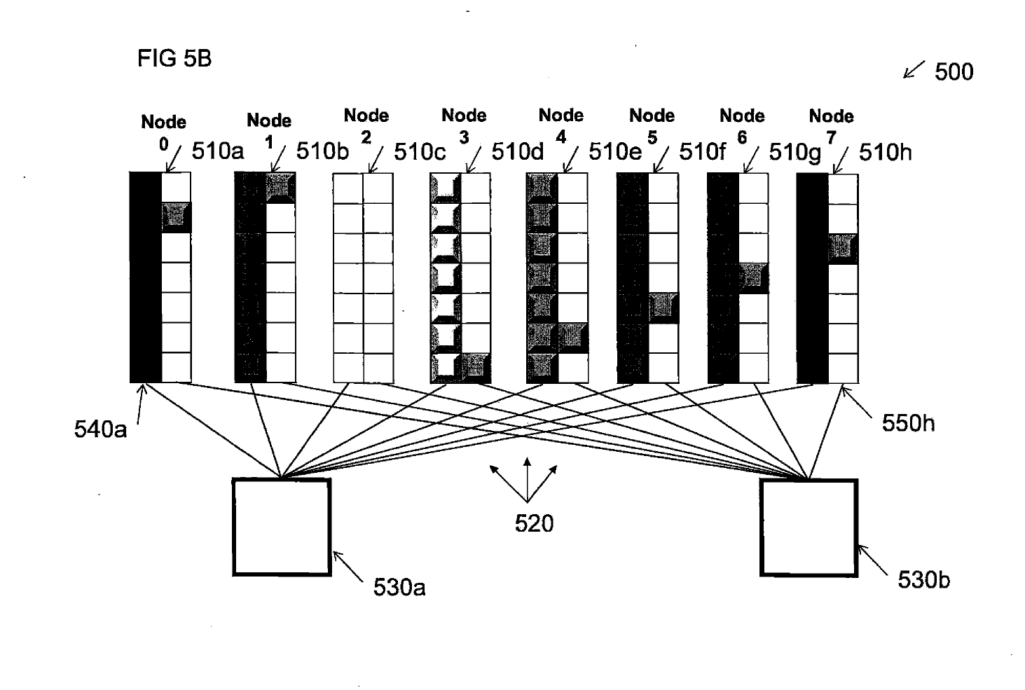

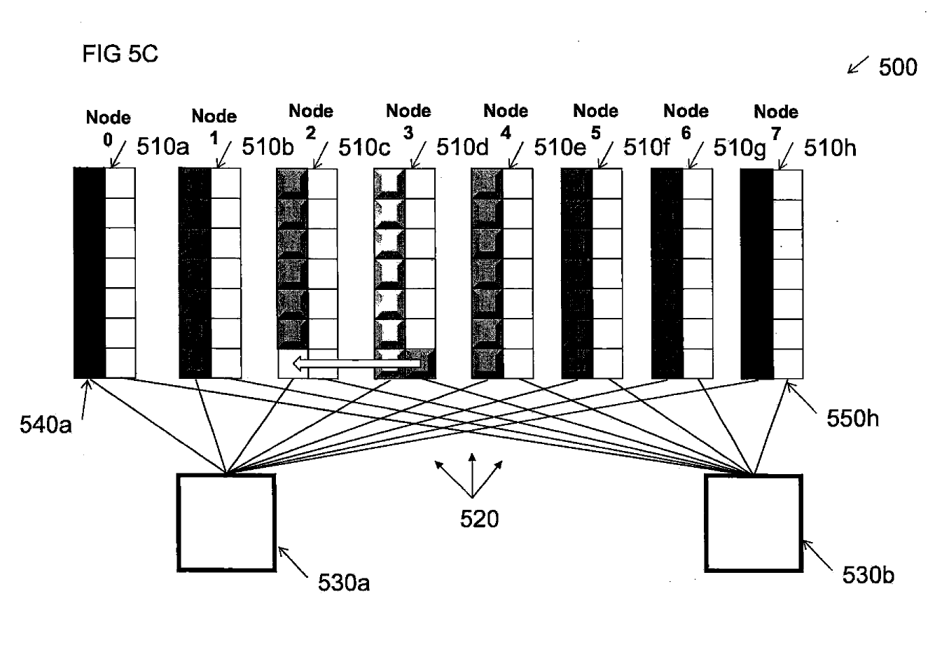

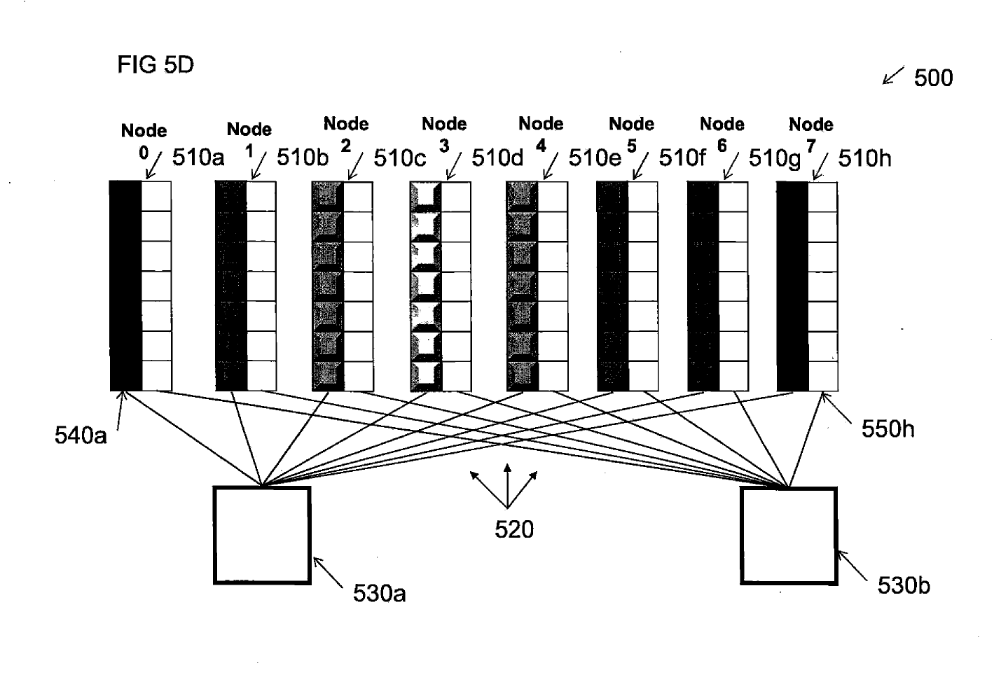

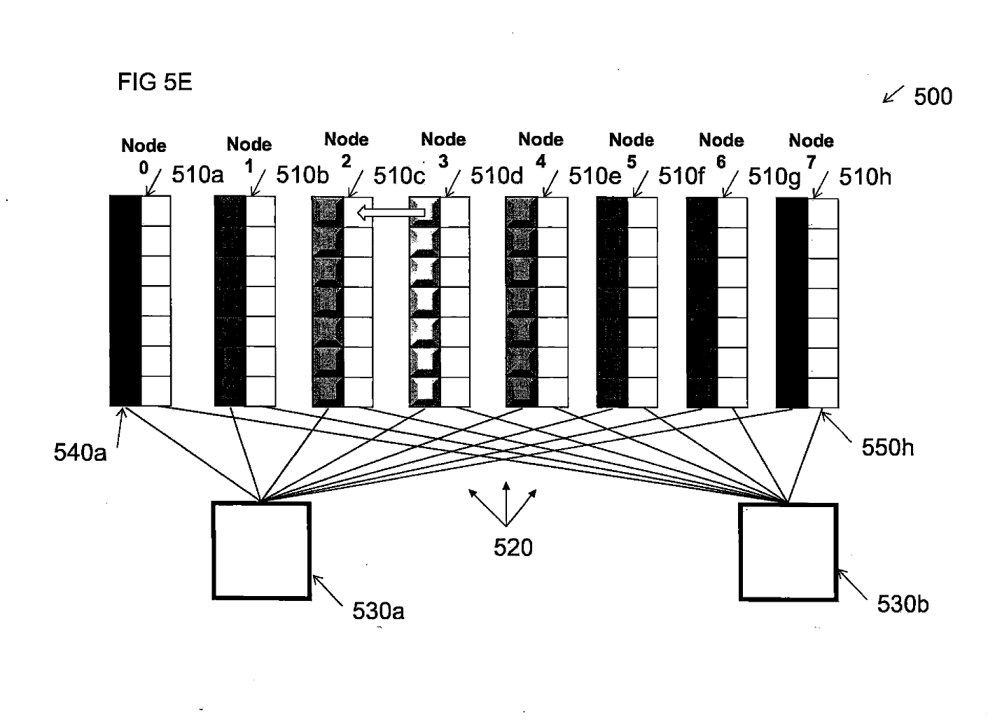

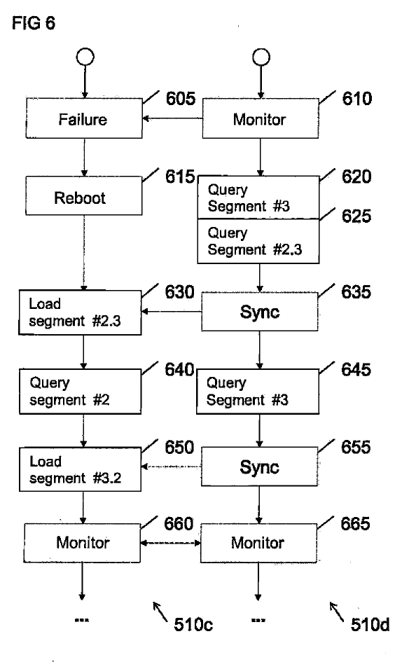

Another main memory database system 500 having eight computer nodes 510 will be described hereafter by FIGS. 5A to 5F and the flow chart according to FIG. 6. For reasons of clarity, only the steps of two computer nodes 510c and 510d are illustrated in FIG. 6.

The main memory database system 500 according to FIGS. 5A to 5F differs from the main memory database systems 100 and 300 described previously inter alia in that the individual database segments and the database software used to query them allow further subdivisions of the individual database segments. For example, the database segments can be split into smaller database parts or containers, wherein all associated data, in particular log and transaction data, can be isolated for a respective database part or container and processed independently of one another. In this way it is possible to query, modify and/or recover individual database parts or containers of a database segment independently of the remaining database parts or containers of the same database segment.

The main memory database system 500 according to FIGS. 5A to 5E additionally differs from the main memory database system 300 according to FIGS. 3A to 3D in that no additional dedicated computer node is provided for creating the redundancy. Instead, in the database system 500 according to FIGS. 5A to 5E, each of the active computer nodes 510 makes a contribution to creating the redundancy of the main memory database system 500. This enables the use inter alia of simple, symmetrical system architectures and avoids the use of asymmetrical connection structures.

As illustrated in FIG. 5A, the main memory database system 500 comprises a total of eight computer node 510a to 510h, which in FIG. 5A are denoted by the designations “Node 0” to “Node 7.” The individual computer nodes 510a to 510h connect to one another via network lines 520 and network switches 530. In the example, this purpose is served by, per computer node 510, two 10 Gbit Ethernet network lines that are redundant in relation to one another and each connect to an eight-port 10 Gbit Ethernet switch. Each of the computer nodes 510a to 510h has a first memory area 540a to 540h and a second memory area 550a to 550h stored in a non-volatile memory of the respective computer node 510a to 510h. In the example, this may involve, for example, memory areas of a local non-volatile semiconductor memory, for example, of an SSD or a non-volatile main memory.

The database of the main memory database system 500 in the configuration illustrated in FIG. 5A is again split into eight database segments, which are stored in the first memory areas 540a to 540h and can be queried and actively changed independently of one another by the eight computer nodes 510a to 510h. The actively queryable memory areas are each highlighted three-dimensionally in FIGS. 5A to 5E. One seventh of a database segment of each one of the other computer nodes 510 is stored as a passive copy in the second memory areas 550a to 550h of each computer node 510a to 510h. The memory structure of the second memory area 550 corresponds substantially to the memory structure of the second memory areas 350 already described with reference to FIGS. 3A to 3D.

In the state illustrated in FIG. 5B, the computer node 510c designated “Node 2” has failed. This is illustrated as step 605 in the associated flow chart shown in FIG. 6. This failure is recognized in step 610 by one, several or all of the remaining active computer nodes 510a and 510b and 510d to 510h or by an external monitoring component, for example, in the form of a scheduler of the main memory database system 500. To remedy the error state, in step 615 the failed computer node 510c is rebooted. Parallel to that, each of the remaining active computer nodes, in addition to responding to queries relating to its own database segment (step 620), takes over a part of the query load relating to the database segment of the failed computer node 510c (step 625). In addition to processing its own queries of the segment of “Node 3” in step 620, the active computer node 510d thus takes over querying that part of the database segment of “Node 2” stored locally in the memory area 550d. In FIG. 5B this is depicted by highlighting the parts of the database segment of the failed node 510c stored redundantly in the second memory area 550. In other words, parts of the memory areas containing previously passive database parts are converted into queryable memory areas and active database parts. For example, database software used to query can be informed which memory areas it is controlling actively as master or passively as slave according to changes of a different master.

Once rebooting of the failed computer node 510c is complete, in step 630 this loads parts of the database segment assigned to it out of one of the non-volatile memories of the other active computer nodes 510a, 510b and 510d to 510h. At the same time, for example, the entire part of the database can be loaded from the other computer nodes 510. As soon as the loading and optionally the synchronization of the part of the database segment is complete, the rebooted computer node 510c, optionally after transfer of the data into the main memory, also undertakes processing of the queries associated with the database part. For that purpose, the corresponding part of the database in the second memory area 550d is deactivated and activated in the first memory area 540c of the computer node 510c. The steps 630 and 635 are repeated in parallel or successively for all database parts in the computer nodes 510a, 510b and 510d to 510h. In the situation illustrated in FIG. 5C, the first six parts of the database segment assigned to computer node 510c have been recovered again from the computer nodes 510b, 510a, 510h, 510g, 510f and 510e. FIG. 5C illustrates implementation of steps 630 and 635 to recover the last part of the database segment of computer node 510c being stored redundantly on computer node 510d.

The main memory database system 500 is then in the state illustrated in FIG. 5D, in which each computer node 510a to 510h contains its own database segment in its first memory area 340a to 340h and actively queries this. In this state, changes to the main memory database system 500 can be queried as usual in steps 640 and 645 by parallel querying of the database segments assigned to the respective computer nodes 510a to 510h. The state according to FIG. 5D further differs from the initial situation according to FIG. 5A in that the second memory area 550c of the previously failed computer node 510c does not contain any current data of the remaining computer nodes 510a, 510b and 510d to 510h. In this state, the database segments of computer nodes 510a, 510b and 510d to 510h are thus not fully protected against node failures and the main memory database system 500 as a whole is not in a highly available operating mode.

To restore the redundancy of the database system 500, in steps 650 and 655, as described above in relation to the steps 630 and 635, in each case a part of the database segment of a different computer node 510a, 510b and 510d to 510h is recovered in the second memory area 550c of the computer node 510c. This is illustrated in FIG. 5E by way of example for the copying of a part of the database segment of node 510d into the second memory area 550c of the computer node 510c. Steps 630 and 635 are also repeated in parallel or successively for all computer nodes 510a, 510b and 510d to 510h.

Once steps 650 and 655 have been carried out for each of the computer nodes 510a, 510b and 510d to 510h, the main memory database system 500 is again in the highly available basic state according to FIG. 5A. In this state, the individual computer nodes 510a, to 510h monitor each other for a failure, as is illustrated in steps 660 and 665 using computer nodes 510c and 510d as an example.

The configuration of the main memory database system 500 illustrated in FIGS. 5A to 5E comprises inter alia the advantage that no additional computer node is needed to create the redundancy. To ensure the described shortening of the failover time, it is advantageous if individual parts of a database segment of a failed computer node 510c can be queried independently of one another by different computer nodes 510a, 510b and 510d to 510h. The size of the individually queryable parts or containers can correspond here, for example, to the size of a local memory assigned to a processor core of a multiple processor computer node (known as “ccNUMA awareness”). Since in the transitional period, as shown, for example, in FIGS. 5B and 5C, queries relating to the database segment of the failed computer node 510c can continue to be answered, even if with a slightly reduced performance, the communication complexity until the query capability is restored can be considerably reduced. As a consequence, the connection structure, comprising the network connections 520 and the network switches 530, can be implemented with comparatively inexpensive hardware components without the failover time being increased.

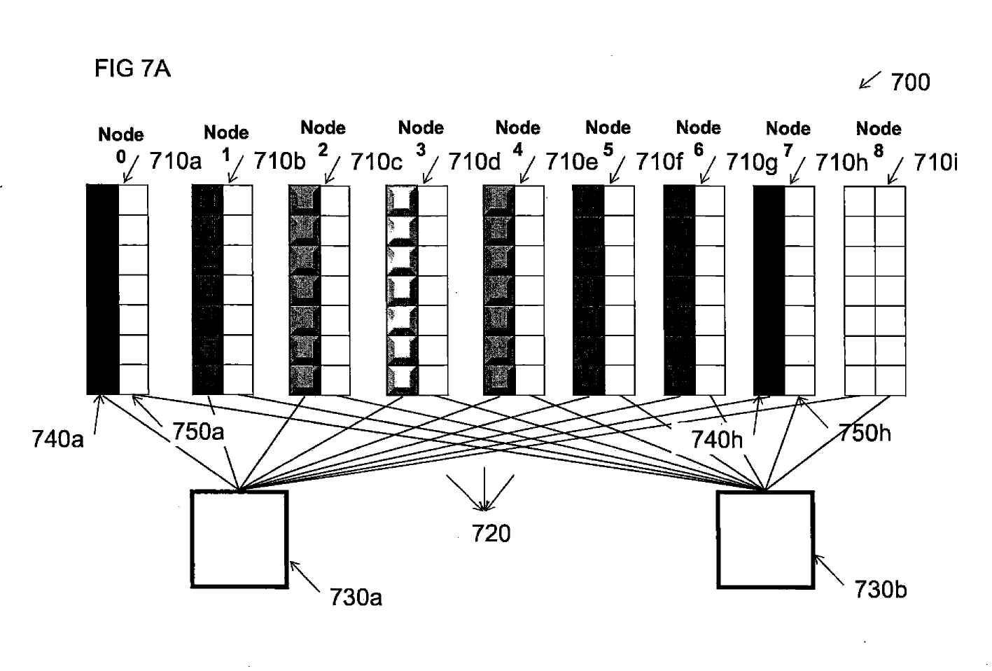

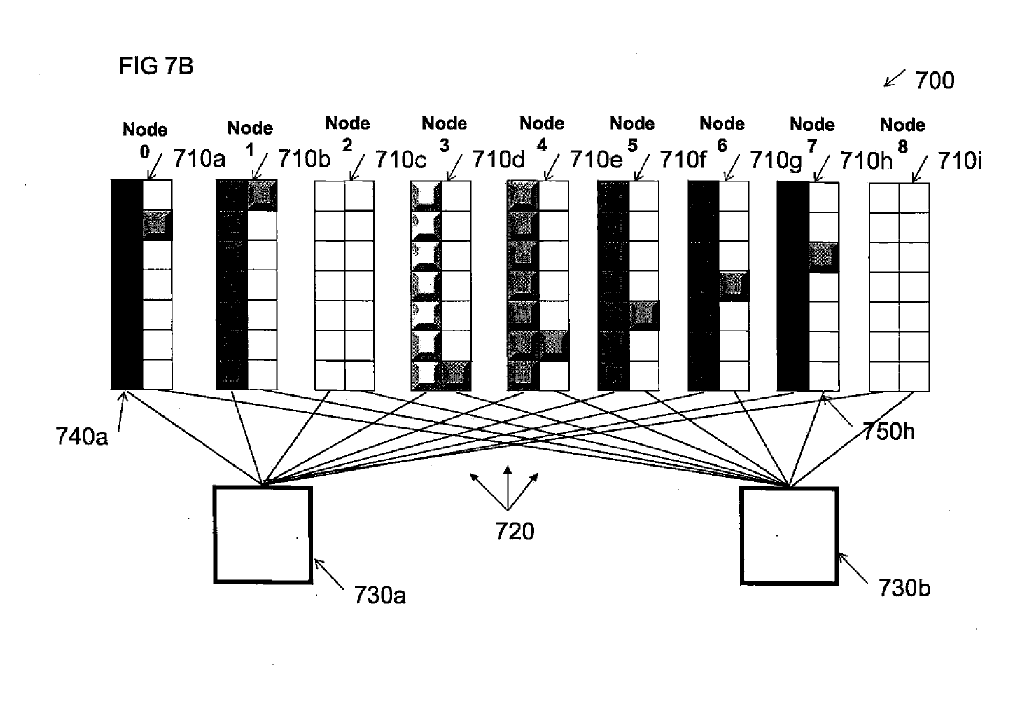

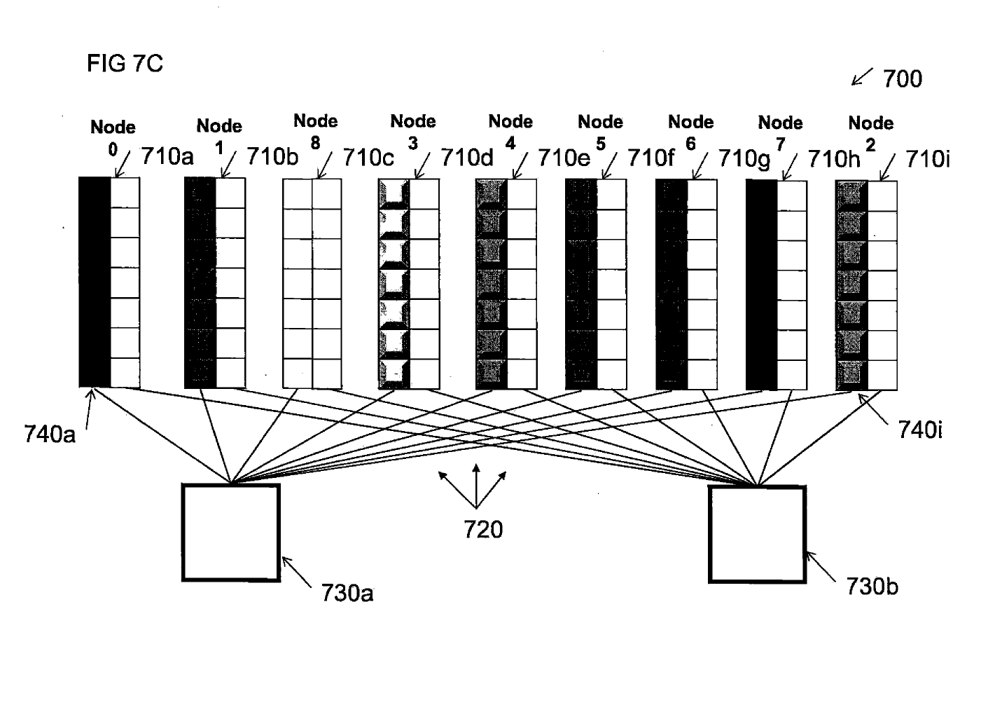

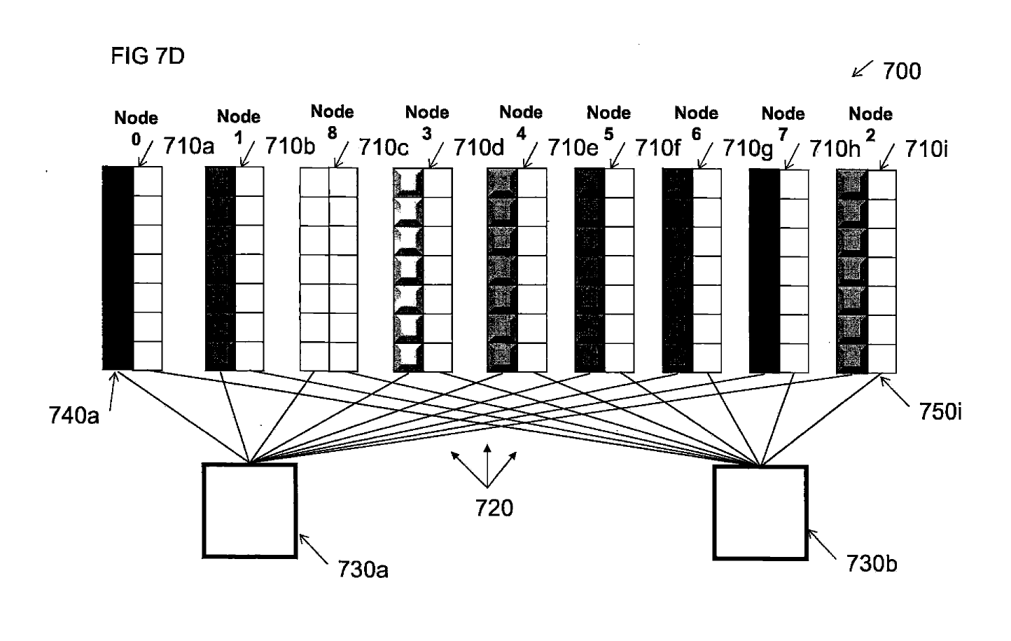

A combination of the techniques according to FIGS. 3A to 6 is described hereafter according to a further example, based on FIGS. 7A to 7D.

FIG. 7A shows a main memory database system 700 with a total of nine computer nodes 710 in an 8+1 configuration. The computer nodes 710a to 710i have a memory distribution corresponding to the memory distribution of the main memory database system 300 according to FIG. 3A. This means in particular that the main memory database system 700 has eight active computer nodes 710a to 710h and one redundant computer node 710i. In each of the active computer nodes 710a to 710h there is a complete database segment assigned to the respective computer node 710a to 710h, which is stored in a first memory area 740a to 740h that can be queried by associated database software. Moreover, a seventh of a database segment of each one of the other active computer nodes 710 is stored in a respective second memory area 750a to 750h. The computer nodes 710a to 710i are, as described with reference to FIG. 5A, connected to one another by a connection structure, comprising network lines 720 and network switches 730. In the example, these connections are again connections according to what is commonly called the 10 Gbit Ethernet standard.

The behavior of the main memory database system 700 upon failure of a node, for example, the computer node 710c, corresponds substantially to a combination of the behavior of the previously described examples. If, as shown in FIG. 7B, the computer node 710c fails, first of all in a transitional phase the remaining active nodes 710a, 710b and 710d to 710h take over the querying in each case of a separately queryable part of a database segment assigned to the failed database node 710c. Responding to queries to the main memory database system 700 upon failure of the computer node 710c can thus be continued without interruption.

The individual parts that together form the failed database segment are subsequently transferred by the active nodes 710a, 710b and 710d to 710h to the memory area 740i of the redundant node 710i. This situation is illustrated in FIG. 7C. As described above with reference to the method 600 according to FIG. 6, the individual parts of the failed database segment can be transferred successively, without interruption to the operation of the database system 700. The transfer can therefore be effected via comparatively simple, conventional network technology such as, for example, 10 Gbit Ethernet. To restore redundancy of the main memory database system 700, a part of the database segment of the remaining active computer nodes 710a, 710b and 710d to 710h, respectively, is subsequently transferred to the second memory area 750i of the redundant computer node 710i, as illustrated in FIG. 7D.

Furthermore, the failed computer node 710c can be rebooted in parallel so that this computer node can take over the function of the redundant computer node after reintegration into the main memory database system 700. This is likewise illustrated in FIG. 7D. In addition to the combination of the advantages described with reference to the example according to FIGS. 3A to 6, the main memory database system 700 according to FIGS. 7A to 7D has the additional advantage that even upon failure of two computer nodes 710, operation of the main memory database system 700 as a whole can be ensured and, on permanent failure of one computer node 710, there is only a short-term loss of performance.

The described operating modes and architectures of the different main memory database systems 100, 300, 500 and 700 described enable, as described, the failover time to be shortened in the event of failure of an individual computer node of the main memory database system in question. This is achieved at least partly by using a node-internal, non-volatile mass storage device to store the database segment assigned to a particular computer node, or a local mass storage device of another computer node of the same cluster system. Internal, non-volatile mass storage devices generally connect via especially high-performance bus systems to associated data-processing components, in particular processors of the particular computer nodes so that data of a node that may have failed can be recovered with a higher bandwidth than would be the case when re-loading from an external storage device.

Moreover, some of the described configurations offer the advantage that recovery of data from a plurality of mass storage devices can be carried out in parallel so that the available bandwidth is added up. In addition, the described configurations provide advantages not only upon failure of an individual computer node of a main memory database system having a plurality of computer nodes, but also allow the faster, optionally parallel, initial loading of the database segments of a main memory database system, for example, after booting up the system for the first time upon a complete failure of the entire main memory database system.

In each of the main memory database systems 100, 300, 500 and 700 described, the entire database and all associated database segments are stored redundantly to safeguard the entire database against failure. It is also possible, however, to apply the procedures described here only to individual, selected database segments, for example, when only the selected database segments are used for time-critical queries. Other database segments can then be recovered as before in a conventional manner, for example, from a central network storage device.

1. A highly available main memory database system comprising:
a plurality of computer nodes comprising at least one computer node that creates a redundancy of the database system; and
at least one connection structure that creates a data link between the plurality of computer nodes;
wherein
each of the computer nodes has at least one local non-volatile memory that stores a database segment assigned to the particular computer node, at least one data-processing component that runs database software to query the database segment assigned to the computer node and a synchronization component that redundantly stores a copy of the data of a database segment assigned to a particular computer node in at least one non-volatile memory of at least one other computer node; and
upon failure of at least one of the plurality of computer nodes, at least the at least one computer node that creates the redundancy runs the database software to query at least a part of the database segment assigned to the failed computer node based on a copy of associated data in the local non-volatile memory to reduce latency upon failure of the computer node.

2. The system according to claim 1, wherein each computer node comprises at least one volatile main memory that stores a working copy of the associated database segment and a non-volatile mass storage device that stores the database segment assigned to the computer node and a copy of the data of at least a part of a database segment assigned to a different computer node and, wherein, upon failure of at least one of the plurality of computer nodes, the computer node that creates the redundancy loads at least a part of the database segment assigned to the failed computer node from a copy in a non-volatile mass storage device via a local bus system into the volatile main memory.

3. The system according to claim 2, wherein the at least one data processing component of each computer node connects via at least one direct-attached storage (DAS) connection according to a Small Computer System Interface (SCSI) and/or a PCI Express (PCIe) standard, according to Serial Attached SCSI (SAS), SCSI over PCIe (SOP) standard and/or the NVM Express (NVMe) to the non-volatile mass storage device of the computer node.

4. The system according to claim 2, wherein the non-volatile mass storage device comprises a semiconductor mass storage device, an SSD drive, a PCIe-SSD plug-in card or a DIMM-SSD memory module.

5. The system according to claim 1, wherein each computer node has at least one non-volatile main memory with a working copy of at least one part of the entire assigned database segment or data and associated log data of the entire assigned segment of the database.

6. The system according to claim 1, wherein the connection structure comprises at least one parallel switching fabric to exchange data between at least one first computer node of the plurality of computer nodes and the at least one computer node that creates the redundancy via a plurality of parallel connection paths via a plurality of PCI-Express data lines.

7. The system according to claim 1, wherein at least one first computer node of the plurality of computer nodes and the at least one computer node that creates the redundancy connect to one another via at least one or more serial high speed lines according to the InfiniBand standard.

8. The system according to claim 1, wherein at least one first computer node and at least one second computer node are coupled to one another via the connection structure such that the first computer node is able to directly access content of a working memory of the at least one second computer node according to a Remote Direct Memory Access (RDMA), the RDMA over Converged Ethernet or the SCSI RDMA protocol.

9. The system according to claim 1, wherein the plurality of computer nodes comprises a first computer node and a second computer node, an entire database is assigned to the first computer node and stored in the non-volatile local memory of the first computer node, a copy of the entire database is stored redundantly in the non-volatile local memory of the second computer node, and wherein in a normal operating state, the database software of the first computer node responds to queries to the database, database changes caused by the queries are synchronized with the copy of the database stored in the non-volatile memory of the second computer node and the database software of the second computer node responds to queries to the database at least upon failure of the first computer node.

10. The system according to claim 1, wherein the plurality of computer nodes comprises a first number n, n>1, of active computer nodes and each of the active computer nodes stores in its non-volatile local memory a different one of in total n independently queryable database segments and at least one copy of the data of at least a part of a database segment assigned to a different active computer node.

11. The system according to claim 10, wherein the plurality of computer nodes additionally comprises a second number m, m>1, of passive computer nodes that creates the redundancy to which in a normal operating state has no database segment is assigned.

12. The system according to claim 11, wherein the at least one passive computer node, upon failure of an active computer node, recovers the database segment assigned to the failed computer node in the local non-volatile memory of the at least one passive computer node based on copies of the data of the database segment in the non-volatile local memories of the remaining active computer node and to respond to queries relating to the database segment assigned to the failed computer node based on the recovered database segment.

13. The system according to claim 10, wherein each of the active computer nodes, upon failure of another active computer node, in addition to responding to queries relating to the database segment assigned to the respective computer node, also responds to at least some queries relating to the database segment assigned to the failed computer node, based on the copy of the data of the database segment assigned to the failed computer node stored in the local memory of the respective computer node.

14. A method of operating the system according to claim 1 with a plurality of computer nodes, comprising:
storing at least one first database segment in a non-volatile local memory of a first computer node;
storing a copy of the at least one first database segment in at least one non-volatile local memory of at least one second computer node;
executing database queries with respect to the first database segment by the first computer node;
storing database changes with respect to the first database segment in the non-volatile local memory of the first computer node;
storing a copy of the database changes with respect to the first database segment in the non-volatile local memory of the at least one second computer node; and
executing database queries with respect to the first database segment by a redundant computer node based on the stored copy of the first database segment and/or the stored copy of the database changes should the first computer node fail.

15. The method according to claim 14, further comprising:
recovering the first database segment in a non-volatile local memory of the redundant and/or failed computer node based on the copy of the first database segment and/or the copy of the database changes of the first database segment stored in the at least one non-volatile memory of the at least one second computer node.

16. The method according to claim 14, further comprising:
copying at least a part of at least one other database segment redundantly stored in the failed computer node, by at least one third computer node into the non-volatile memory of the redundant and/or failed computer node to restore a redundancy of the other database segment.

17. (canceled)

18. (canceled)
